(19) United States
(12) Patent Application Publication
(10) Pub. No.: US 2025/0372873 A1
(43) Pub. Date: Dec. 4, 2025

(54) TERMINAL ANTENNA, ANTENNA SYSTEM, AND ELECTRONIC DEVICE

(71) Applicant: HONOR DEVICE CO., LTD., Shenzhen (CN)

(72) Inventors: Ruoqing Zhu, Shenzhen (CN); Yuanpeng Li, Shenzhen (CN)

(21) Appl. No.: 19/298,550

(22) Filed: Aug. 13, 2025

Related U.S. Application Data
(63) Continuation of application No. PCT/CN2023/131431, filed on Nov. 14, 2023.

(30) Foreign Application Priority Data
Feb. 15, 2023 (CN) 202310162877.X

(51) Int. Cl. H01Q 5/371; H01Q 1/24; H01Q 1/48; H01Q 9/04

(52) U.S. Cl. CPC H01Q 5/371; H01Q 1/243; H01Q 1/48; H01Q 9/0407

(57) ABSTRACT

Embodiments of this application disclose a terminal antenna, an antenna system, and an electronic device, which relate to the field of antenna technologies. The specific solution is: a first radiator and a second radiator, where two ends of the first radiator are respectively provided with a first feed point and a first ground point, and the second radiator is provided with at least one ground point. The first feed point is coupled to a first feed, and the first ground point and the at least one ground point on the second radiator are separately coupled to a reference ground. When the antenna is in operation, a first current is distributed on the first radiator. A second current is distributed in a first region on the second radiator. The first current and the second current have a same direction.

### CROSS-REFERENCE TO RELATED APPLICATIONS

This application is a continuation of International Application No. P PCT/CN2023/131431, filed on Nov. 14, 2023, which claims priority to Chinese Patent Application No. 202310162877.X, filed on Feb. 15, 2023, both of which are incorporated herein by reference in their entireties.

### TECHNICAL FIELD

Embodiments of this application relate to the field of antenna technologies, and in particular, to a terminal antenna, an antenna system, and an electronic device.

### BACKGROUND

One or more metal decoration members are arranged in an electronic device, to provide rigid support for corresponding modules.

With the development of communication technologies, the quantity of antennas in the limited space of the electronic device is increasing. Some antennas are arranged near the metal decoration member.

As a conductor with a relatively large area, the metal decoration member significantly affects the radiation performance of nearby antennas.

### SUMMARY

Embodiments of this application provide a terminal antenna, an antenna system, and an electronic device, which can provide support for radiation of an antenna while avoiding influence of a metal Deco on antenna radiation through a proper design of the metal Deco near the antenna. Therefore, better radiation performance and more frequency band coverage are achieved.

To achieve the foregoing objective, the following technical solutions are used in the embodiments of this application:

According to a first aspect, a terminal antenna is provided. The terminal antenna is arranged in an electronic device, and the antenna includes: a first radiator and a second radiator, where two ends of the first radiator are respectively provided with a first feed point and a first ground point, and the second radiator is provided with at least one ground point. The first feed point is coupled to a first feed, and the first ground point and the at least one ground point on the second radiator are separately coupled to a reference ground. When the antenna is in operation, a first current is distributed on the first radiator. A second current is distributed in a first region on the second radiator. The first region is on a side of the second radiator close to the first radiator, and the first region corresponds to a region in which the first radiator is projected onto the second radiator. The first current and the second current have the same direction.

In this way, by providing the ground point on the second radiator, a current in the same direction as that on the first radiator can be generated at a position on the second radiator close to the first ground point. Therefore, the radiation generated by the current in the same direction on the second radiator not only does not affect the radiation of the first radiator, but can also produce a positive superposition effect on the radiation of the first radiator, thereby improving the overall radiation performance.

Optionally, the electronic device has a metal frame architecture, at least a part of a metal frame of the electronic device is reused for the first radiator, and a metal decoration member in the electronic device is reused for the second radiator.

It is to be noted that, in this example, the metal frame being reused for a radiator of a first antenna is used as an example. In some other embodiments, the radiator of the first antenna may alternatively be in the form of LDS, MDA, FPC, or the like.

Optionally, a minimum distance between the first radiator and the second radiator does not exceed 15 mm.

Optionally, the at least one ground point on the second radiator includes a second ground point, and the second ground point is provided in the first region.

Optionally, that two ends of the first radiator are respectively provided with a first feed point and a first ground point includes: a first end of the first radiator is provided with the first ground point. That the second ground point is provided in the first region includes: the second ground point is provided at the first end of the first region. The first end of the first region corresponds to a projection position of the first end of the first radiator in the first region.

In the example, the second ground point may be provided at a position corresponding a ground point of the first radiator. Therefore, the current coupled to the second radiator close to the first radiator can generate an effect of being in the same direction as that on the first radiator in a projection region (that is, the first region) of the first radiator.

Optionally, an operating frequency band of the first antenna includes a first frequency band. The at least one ground point on the second radiator includes a third ground point. That two ends of the first radiator are respectively provided with a first feed point and a first ground point includes: a first end of the first radiator is provided with the first ground point. The projection position of the first end of the first radiator in the first region is a first position. A distance between the third ground point and a first straight line corresponds to ½ wavelength of the first frequency band. The first straight line passes through the first position, and the first straight line is perpendicular to a straight line on which the first radiator is located.

In the example, the ground point on the second radiator may alternatively be at an end in the first region away from the ground point of the first radiator. In this way, by controlling the distance between the third ground point and the projection position of the ground point of the first radiator on the second radiator, the current in the same direction generated in the first region on the second radiator can operate on the same frequency band as the first radiator. Therefore, the two currents in the same direction can have the effect of superimposition in the same frequency band.

Optionally, when the antenna is in operation, the first radiator operates on the first frequency band, a third current is distributed on the side of the second radiator close to the first radiator, the third current includes the second current, and the third current is configured to excite a one-wavelength mode covering the first frequency band on the second radiator.

Therefore, it is clear that the operating mode on the side of the second radiator close to the first radiator may be a one-wavelength mode. The current of a part of the one-wavelength mode (for example, one ½ wavelength thereof) may have the same direction as the current on the first radiator.

Optionally, a straight line on which the third current on the second radiator is located is parallel to a straight line on which the first current on the first radiator is located.

For example, both the third current and the first current may be parallel to a straight line on which a long side of the electronic device is located.

Optionally, the operating frequency band of the first antenna includes a second frequency band. That the second radiator is provided with at least one ground point includes: the second radiator is provided with a fourth ground point. That two ends of the first radiator are respectively provided with a first feed point and a first ground point includes: a first end of the first radiator is provided with the first ground point. The projection position of the first end of the first radiator in the first region is a first position. A distance between the fourth ground point and a second straight line corresponds to ½ wavelength or ¼ wavelength of the second frequency band. The second straight line passes through the first position, and the first straight line is parallel to the straight line on which the first radiator is located.

In the example, the second radiator may be further provided with a ground point away from the first radiator. The providing of the ground point can excite a current mode whose direction is perpendicular to the third current on the second radiator. For example, when the third current is longitudinal, the current mode may be a transverse mode. The transverse mode may be controlled by the distance between the fourth ground point and the second straight line to achieve excitation in a ½ wavelength mode or a ¼ wavelength mode, thereby achieving coverage of the second frequency band.

In some implementations, the first frequency band may be a 2.4 GHz or 5 GHz WIFI frequency band, and the second frequency band may be a GPS frequency band.

Optionally, the second radiator is further provided with a second feed point, and the second feed point is coupled to a second feed. The second feed is configured to feed a signal to the second radiator through the second feed point, so that the second radiator operates on a third frequency band.

Therefore, by adding a feed to the second radiator, the second radiator can be excited to operate in the foregoing transverse mode and/or longitudinal mode while performing Patch antenna radiation. The third frequency band can correspond to an area of the second radiator. A larger area of the second radiator indicates a lower third frequency band. Conversely, a smaller area of the second radiator indicates a higher third frequency band. In this way, the quantity of frequency bands covered by the terminal antenna is increased without adding new radiators.

Certainly, in some implementations, the coverage of the third frequency band can also be used to enhance the bandwidth of the first frequency band and/or the second frequency band.

According to a second aspect, an antenna system is provided. The antenna system is applicable to an electronic device, and the antenna system includes a first antenna and a second antenna, where the first antenna is the terminal antenna according to the first aspect and any possible design of the first aspect. An operating frequency band of the antenna system includes a first frequency band, a second frequency band, and a third frequency band. The first radiator and the second radiator of the first antenna are configured to cover the first frequency band. The second radiator of the first antenna and the second antenna are configured to cover the second frequency band. The second radiator of the first antenna is further configured to cover the third frequency band.

Optionally, the second radiator of the first antenna includes the fourth ground point, and the first end of the first radiator of the first antenna is provided with the first ground point. The projection position of the first end of the first radiator in the first region is the first position. The first region is on a side of the second radiator close to the first radiator, and the first region corresponds to a region in which the first radiator is projected onto the second radiator. The distance between the fourth ground point and the second straight line corresponds to ½ wavelength of the second frequency band. The second straight line passes through the first position, and the first straight line is parallel to the straight line on which the first radiator is located. Therefore, during arrangement of the second antenna, the transverse-mode current distribution on the second radiator can be differentiated from the current distribution on the second antenna, thereby ensuring the isolation between the two antennas when the transverse mode and the second radiator cover the same frequency band (for example, the second frequency band).

Optionally, the electronic device has a metal frame architecture, at least a part of a metal frame on a first side of the electronic device is reused for the first radiator of the first antenna, at least a part of a metal frame on a second side of the electronic device is reused for a radiator of the second antenna, and the first side and the second side are two adjacent sides.

Optionally, the second radiator of the first antenna is arranged near an intersection point between the second side and the third side, and a minimum distance from the second radiator to the second side or the third side does not exceed 15 mm.

According to a third aspect, an electronic device is provided. The electronic device is provided with at least one processor, a radio frequency module, the terminal antenna according to the first aspect and any possible design of the first aspect, and/or the antenna system according to the second aspect and any possible design of the second aspect. When the electronic device sends or receives signals, the signals are sent or received through the radio frequency module, the terminal antenna, and/or the antenna system.

It is to be understood that the technical features of the technical solution provided in the second aspect and the third aspect above can all correspond to the solution provided in the first aspect and any possible design of the first aspect, so that the similar beneficial effects can be achieved. Details are not described herein again.

### BRIEF DESCRIPTION OF DRAWINGS

FIG. 1 is a schematic back view of an electronic device;

FIG. 2 is a schematic side view of an electronic device;

FIG. 3 is a schematic diagram of stacking near a camera module of an electronic device;

FIG. 4 is a schematic diagram of arrangement of an antenna;

FIG. 5 is a schematic diagram of grounding setting of a metal decoration member;

FIG. 6 is a schematic diagram of a comparison of current distributions on a metal decoration member and an antenna;

FIG. 7 is a schematic diagram of a comparison of current distributions on an antenna and a metal decoration member according to an embodiment of this application;

FIG. 8 is a schematic diagram of working logic of an antenna solution according to an embodiment of this application;

FIG. 9 is a schematic diagram of working logic of an antenna solution according to an embodiment of this application;

FIG. 10 is a schematic diagram of working logic of an antenna solution according to an embodiment of this application;

FIG. 11 is a schematic diagram of working logic of an antenna solution according to an embodiment of this application;

FIG. 12 is a schematic diagram of a setting range of a ground point 33 according to an embodiment of this application;

FIG. 13 is a schematic diagram of S-parameter simulation of an antenna solution according to an embodiment of this application;

FIG. 14 is a schematic diagram of working logic of an antenna solution according to an embodiment of this application;

FIG. 15 is a schematic diagram of working logic of an antenna solution according to an embodiment of this application;

FIG. 16 is a schematic diagram of working logic of an antenna solution according to an embodiment of this application;

FIG. 17 is a schematic diagram of working logic of an antenna solution according to an embodiment of this application;

FIG. 18 is a schematic diagram of S-parameter simulation of an antenna solution according to an embodiment of this application;

FIG. 19 is a schematic diagram of working logic of an antenna solution according to an embodiment of this application;

FIG. 20 is a schematic diagram of current simulation of an antenna solution according to an embodiment of this application;

FIG. 21 is a schematic diagram of current simulation of an antenna solution according to an embodiment of this application;

FIG. 22 is a schematic diagram of S-parameter simulation of an antenna solution according to an embodiment of this application;

FIG. 23 is a schematic diagram of ECC-parameter simulation of an antenna solution according to an embodiment of this application;

FIG. 24 is a schematic diagram of working logic of an antenna solution according to an embodiment of this application; and

FIG. 25 is a schematic diagram of arrangement of a metal Deco according to an embodiment of this application.

### DESCRIPTION OF EMBODIMENTS

The terms “first” and “second” mentioned below are used merely for the purpose of description, and shall not be construed as indicating or implying relative importance or implying a quantity of indicated technical features. Therefore, a feature limited by “first” or “second” may explicitly or implicitly include one or more of the features. In the description of the embodiments, unless otherwise stated, “a plurality of” means two or more.

The technical solutions provided in the embodiments of this application may be applicable to an electronic device. To describe the technical solution provided in the embodiments of this application in detail, a brief example of the electronic device is first given below.

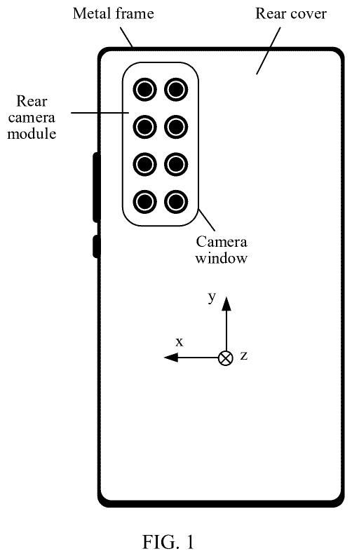

For example, FIG. 1 is a back view of an electronic device. In the example, an example in which the electronic device is a mobile phone, and the mobile phone has a metal frame architecture is used. The metal frame may be arranged on a side periphery of the electronic device. The metal frame may be configured to provide a metal texture to the user, and improve the structural strength of the electronic device.

Generally, the electronic device may be provided with at least one camera module. For example, the at least one camera module may include a front-facing camera module, a rear-facing camera module, and the like. The rear-facing camera module is used as an example. The rear-facing camera module may also be referred to as a rear camera module.

When the rear camera module is in operation, ambient light may be collected through at least one camera included in the rear camera module.

Correspondingly, as shown in FIG. 1, a camera window may be provided on a rear cover of the electronic device. The position of the camera window may correspond to the position of the rear camera module of the electronic device. When the rear cover is buckled on the electronic device, the camera of the rear camera module may extend from the camera window to facilitate light collection during shooting.

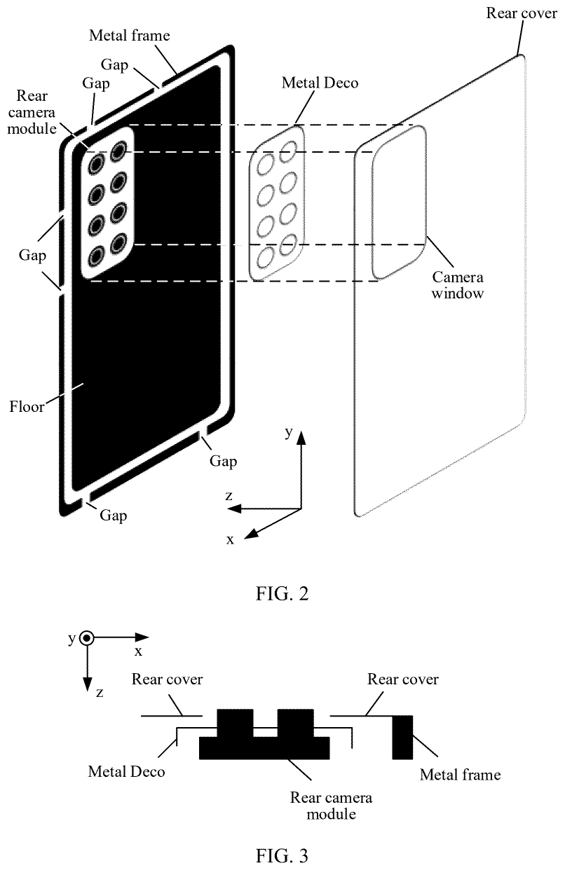

FIG. 2 is a schematic exploded view of some components of an electronic device.

As shown in FIG. 2, a floor may be provided inside the metal frame. The floor may be configured to provide a zero potential reference for various electronic components on the electronic device. For example, the floor may provide a zero potential reference for an antenna arranged in the electronic device.

In some implementations, a printed circuit board (not shown in FIG. 2) may be mounted on the floor. The printed circuit board (which is referred to as PCB or PCB board for short) may be configured to carry various electronic components in the electronic device. For example, a connector may be provided on the PCB, and the connector may be configured for signal transfer between the rear camera module and an image processor provided on the PCB.

In the example shown in FIG. 2, one or more gaps that run through from the inside to the outside may be provided on the metal frame. The plurality of gaps may break the metal frame into a plurality of unconnected parts. Different parts of the metal frame may be reused as components of other parts. For example, the metal frame may be reused as an antenna radiator.

As shown in FIG. 2, a decoration member (Deco) may be further arranged between the rear camera module and the rear cover. In some implementations, the decoration member may be made of a metal material. Correspondingly, the decoration member made of a metal material may be referred to as a metal decoration member, or a metal Deco. As shown in FIG. 2, the metal Deco may be configured to provide rigid protection for the camera in the rear camera module.

It is to be noted that, the example shown in FIG. 2 is only an example of the metal decoration member. In some other implementations, a steel sheet may further be embedded in the metal decoration member to improve the structural strength of the corresponding position.

FIG. 3 illustrates the relative positions of the rear camera module, the metal Deco, the rear cover, and a side metal frame from the tangential direction of the xoz plane.

As shown in FIG. 3, the rear camera module, the metal Deco, and the rear cover are arranged in sequence in the z direction. The metal frame may be located on a side of the metal Deco (for example, the positive direction of the x-axis). The camera of the rear camera module may extend out of the rear cover through the metal Deco from the z direction to collect light.

In the example of FIG. 3, the metal Deco may include a top metal part on the xoy plane and a side metal part on the yoz plane. The side metal part may be arranged on two sides of the top metal part to provide rigid support for the top metal. In a possible implementation, one end of the side metal part is connected to the top metal part, and the other end thereof may be fixed on the PCB. Fixing manners may include welding, crimping, and the like. In different cases, the side metal is not necessarily connected to a reference ground on a mainboard. That is, the metal Deco may be grounded or not grounded.

With the improvement of the shooting capability of the electronic device, arrangement of the rear camera module is becoming more complex. Therefore, the size of the rear camera module continues to expand. The size of the metal Deco may be slightly larger than that of the rear camera module, so that the size of the metal Deco also increases with the expansion of the rear camera module. A distance between the metal Deco and the side (or topside) metal frame is correspondingly shortened. In some cases, a minimum distance between the metal Deco (such as the top metal part and/or the side metal part of the metal Deco) and the side metal frame is already close to or even less than 15 mm.

An antenna may be arranged in the electronic device to implement a wireless communication function of the electronic device. The electronic device shown in FIG. 1 to FIG. 3 is used as an example for illustrating the antenna implementation solution therein.

For example, an example in which the antenna is arranged on a side, for example, a long side on an upper left corner of the back view shown in FIG. 1, is used.

In some embodiments, in the electronic device having a metal frame architecture shown in FIG. 1 to FIG. 3, the metal frame arrangement may be reused for the radiator of the antenna to achieve the radiation objective. The antenna with the radiator for which the metal frame is reused may also be referred to as a frame antenna.

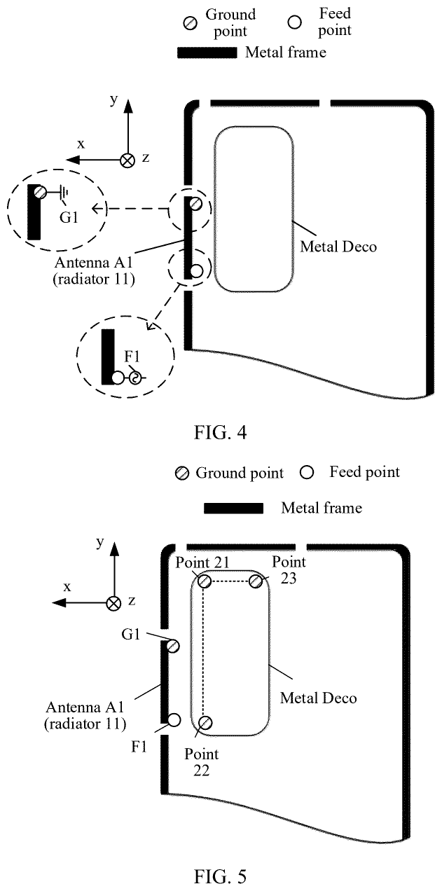

FIG. 4 shows an example of a solution of an antenna A1. As shown in FIG. 4, a metal frame at a corresponding position may be reused for a radiator 11 of the antenna A1. In some implementations, the projection of the metal frame as the radiator of the antenna A1 in the negative direction of the x-axis may include at least a part falling on the metal Deco.

A feed and a ground point may be provided on the radiator of the antenna A1. In the example of the solution shown in FIG. 4, a feed F1 may be provided at a lower end of the radiator, and a ground point G1 may be provided at an upper end of the radiator. In some implementations, the antenna A1 may operate in a left-hand mode for radiation. For example, a capacitor may be connected in series between the feed F1 and the radiator to excite the left-hand mode. In some other implementations, the antenna A1 may alternatively be in other antenna forms, such as an IFA, an ILA, and a loop antenna.

It may be understood that, metal materials near the antenna radiator affect the radiation of the antenna.

With reference to the foregoing description of FIG. 1 to FIG. 4, when the metal Deco is close to the radiator 11 of the antenna A1 (for example, the minimum distance is less than 15 mm), the radiation of the antenna A1 is affected.

To deal with the influence of the metal Deco on the antenna A1, grounding may be generally set on the metal Deco, to construct a short-circuit wall to achieve isolation of the radiation of the antenna A1 in operation.

For example, FIG. 5 is a schematic diagram of providing ground points on a metal Deco to construct a short-circuit wall.

As shown in FIG. 5, there may be at least two ground points on the metal Deco.

For example, the ground points on the metal Deco may include a point 21 and a point 22. The point 21 and the point 22 may be respectively provided on one side of the metal Deco close to the radiator of the antenna A1. The radiator of the antenna A1 being arranged on a side is used as an example, then the point 21 and the point 22 on the metal Deco may be provided on one side of the metal Deco close to the side metal frame (for example, the left side). In some implementations, as shown in FIG. 5, the point 21 and the point 22 may be respectively provided at an upper left corner and a lower left corner of the metal Deco. Therefore, a short-circuit wall nearly parallel to the radiator of the antenna A1 can be equivalently constructed between the point 21 and the point 22. The short-circuit wall can effectively isolate inward radiation generated when the antenna A1 is in operation.

In the example shown in FIG. 5, a point 23 for grounding may be further provided on the metal Deco. The point 23 may be provided at an upper right corner of the metal Deco. Therefore, the point 23 and the point 22 can jointly form a transverse short-circuit wall. The transverse short-circuit wall can be configured to further isolate the inward radiation of the antenna A1. In addition, when an antenna is further arranged on the top of the electronic device, the transverse short-circuit wall can also isolate the radiation of the top antenna.

However, in the implementation of the solution shown in FIG. 5, because the metal Deco is close to the antenna radiator, after the grounding shown in FIG. 5 is set, the metal Deco still affects the radiation of the antenna.

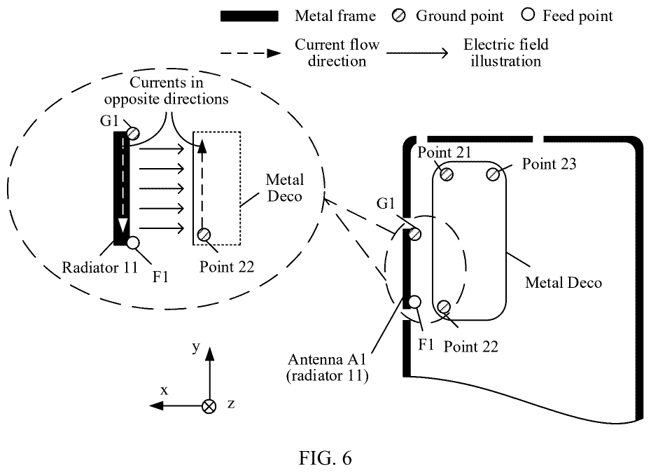

For example, as shown in FIG. 6, an example in which a current flowing from a ground point to a feed is distributed on the antenna radiator at the current moment is used. An electric field in the same direction may be distributed between the antenna radiator and the metal Deco, for example, an electric field directed from the radiator to the metal Deco. Based on electromagnetic coupling of the electric field, a current in the opposite direction to that on the antenna radiator is generated at the edge of the metal Deco close to the antenna radiator. For example, the direction of the current generated on the metal Deco may be from the point 22 to the point 21. It is to be noted that, the electric field example shown in FIG. 6 is only an example of the direction and distribution, and has no correspondence with the electric field strength at various positions in space.

In this way, the currents in opposite directions on the metal Deco and the antenna radiator cause the structure between the metal Deco and the antenna radiator to present an electric field energy storage state at different phases. Therefore, the normal radiation of the antenna A1 is affected. That is, the grounding setting of the metal Deco shown in FIG. 5 or FIG. 6 still has a significant influence on the normal operation of a close antenna (for example, the antenna A1).

It may be understood that, in the foregoing implementation, the antenna A1 close to the metal Deco being a frame antenna is used as an example for description. In some other cases, even if the antenna A1 has other arrangement forms, similar problems still exist. For example, when the antenna A1 is implemented in manners such as laser direct structuring (LDS), metalframe diecasting for anodicoxidation (MDA), and flexible printed circuit (FPC), when the grounding solution shown in FIG. 5 or FIG. 6 is adopted on the metal Deco, the metal Deco also affects the normal operation of the antenna A1.

To resolve the problem that when the metal Deco is arranged close to the antenna (for example, the minimum distance is less than 15 mm), the radiation performance of the antenna is significantly affected, the embodiments of this application provide a terminal antenna, through which at least one ground point can be selected at a preset position on the metal Deco. By providing the at least one ground point, the influence of the metal Deco on the radiation of the antenna body can be avoided.

In addition, by providing at least one ground point at the preset position, the metal Deco can further be effectively excited to produce parasitic resonance, to expand the bandwidth covered by the antenna, and/or improve the performance of the radiation of the antenna body.

In some embodiments, more ground points at preset positions may also be provided on the metal Deco, so that the metal Deco can further excite a current perpendicular to the straight line on which the long side of the antenna radiator is located (for example, a transverse current). By adjusting and setting the positions of the ground points, this current distribution can also be used to improve the radiation performance of the antenna. In some embodiments, when a plurality of same-frequency or adjacent-frequency (that is, the frequency bands at least partially overlap) antennas are arranged in the electronic device, the operating mode of the transverse current is properly adjusted, to enhance the isolation between the antennas, and avoid mutual interference between the antennas.

In some embodiments, additional feeds may further be provided on the metal Deco, so that the metal Deco operates on another frequency band without affecting the original antenna radiation. Therefore, the frequency band coverage of the electronic device is extended.

The technical solution provided in the embodiments of this application is described below in detail with reference to the accompanying drawings.

It is to be noted that, the antenna solution provided in the embodiments of this application may be applied to an electronic device of a user. The electronic device may also be referred to as a terminal device. When the antenna solution provided in the embodiments of this application is set in a terminal device, the antenna may also be referred to as a terminal antenna. The setting of the antenna solution in the electronic device may be used to support a wireless communication function of the electronic device. For example, the electronic device may include a mobile phone shown in FIG. 1 to FIG. 3.

In some other implementations, the electronic device may alternatively be implemented in other forms. For example, the electronic device may be a smart switch, an electronic switch, a tablet computer, a desktop computer, a laptop computer, a handheld computer, a notebook computer, an in-vehicle device, an ultra-mobile personal computer (UMPC), a netbook, a cellular phone, a personal digital assistant (PDA), an augmented reality (AR)/virtual reality (VR) device, or the like. A specific form of the electronic device is not particularly limited in the embodiments of this application.

For example, in terms of hardware composition, the electronic device may include a processor, an external memory interface, an internal memory, a universal serial bus (USB) connector, a charging management module, a power management module, a battery, at least one antenna, a mobile communication module, a wireless communication module, an audio module, a speaker, a phone receiver, a microphone, a headset jack, a sensor module 180, a button, a motor, an indicator, a camera module, a display screen, a subscriber identification module (SIM) card interface, and the like. The sensor module may include a pressure sensor, a gyro sensor, a barometric pressure sensor, a magnetic sensor, an acceleration sensor, a distance sensor, an optical proximity sensor, a fingerprint sensor, a temperature sensor, and a touch sensor, an ambient light sensor, a bone conduction sensor, and the like.

When the electronic device provides a wireless communication function to the user, the at least one antenna can be coupled to the mobile communication module and/or the wireless communication module to realize signal transmission and reception. In some embodiments, when the electronic device can have a metal frame architecture shown in FIG. 1 or FIG. 2, the at least one antenna may be a frame antenna.

For example, in some embodiments, the at least one antenna may include an antenna A1 arranged near a metal Deco and on a long side of the electronic device. In this application, the relative relationship of being nearby is similar to the relative position relationship of being close, which can be understood as that: a minimum distance between a metal frame reused as an antenna radiator and the metal Deco does not exceed 15 mm. The operating frequency band of the antenna A1 may include a first frequency band, or the operating frequency band of the antenna A1 may include a first frequency band and a second frequency band. For example, the first frequency band may be a 2.4G WIFI frequency band. The 2.4G WIFI frequency band may include 2.4 GHz to 2.5 GHz. The second frequency band may be a GPS frequency band. The GPS frequency band may include 1575 MHz.

In some other embodiments, the at least one antenna may include an antenna A1 arranged near the metal Deco and on the long side of the electronic device, and an antenna A2 arranged near the metal Deco and on a short side of the electronic device. The operating frequency band of the antenna A1 is similar to that in the foregoing example. The operating frequency band of the antenna A2 may include a first frequency band, or the operating frequency band of the antenna A2 may include a first frequency band and a second frequency band.

In a possible implementation, the operating frequency band of the antenna A1 may at least partially overlap with the operating frequency band of the antenna A2. For example, the operating frequency band of the antenna A1 includes the 2.4G WIFI frequency band, and the operating frequency band of the antenna A2 includes both the 2.4G WIFI frequency band and the GPS frequency band.

In this example, the camera module may include a rear camera module, a front camera module, and the like. With reference to the foregoing description, the rear camera module may be provided with a corresponding metal Deco. For the arrangement of the metal Deco, reference may be made to the illustration of FIG. 2 or FIG. 3. In different implementations, the x-direction size of the metal Deco may range from 5 mm to 85 mm. The y-direction size of the metal Deco may range from 5 mm to 85 mm.

In the embodiments of this application, at least one ground point may be provided at a preset position on the metal Deco. When the antenna close to the metal Deco is in operation, a current in the same direction as that on the antenna (for example, the antenna A1) can be excited at the corresponding position of the antenna radiator on the metal Deco through electromagnetic coupling, thereby improving the antenna performance.

It is to be noted that, in the existing design, the radiator of the antenna A1 may include a part of the metal frame on the side of the electronic device. Based on the setting of the grounding solution of the metal Deco in this application, the metal Deco can perform radiation as a part of the antenna A1. Therefore, in this application, the radiator of the antenna A1 may include a part of the metal frame on the side of the electronic device and the metal Deco.

It may be understood that, the structure shown in this embodiment of this application does not constitute a specific limitation on the electronic device.

For example, the antenna A1 and/or the antenna A2 in the electronic device may alternatively be implemented in the form of FPC, LDS, MDA, or the like. The effects that can be achieved are similar, and details are not described herein again.

In some other embodiments of this application, the electronic device may include more or fewer components, or some components may be combined, or some components may be split, or a different component arrangement may be used. The components may be implemented by hardware, software, or a combination of software and hardware.

The terminal antenna solution provided in the embodiments of this application will be described below in detail with reference to the accompanying drawings. The terminal antenna solution can achieve its effects through the corresponding grounding setting on the metal Deco.

With reference to the description of FIG. 4 to FIG. 6, an example in which a frame antenna A1 located on a side of the electronic device is arranged near the metal Deco is still used.

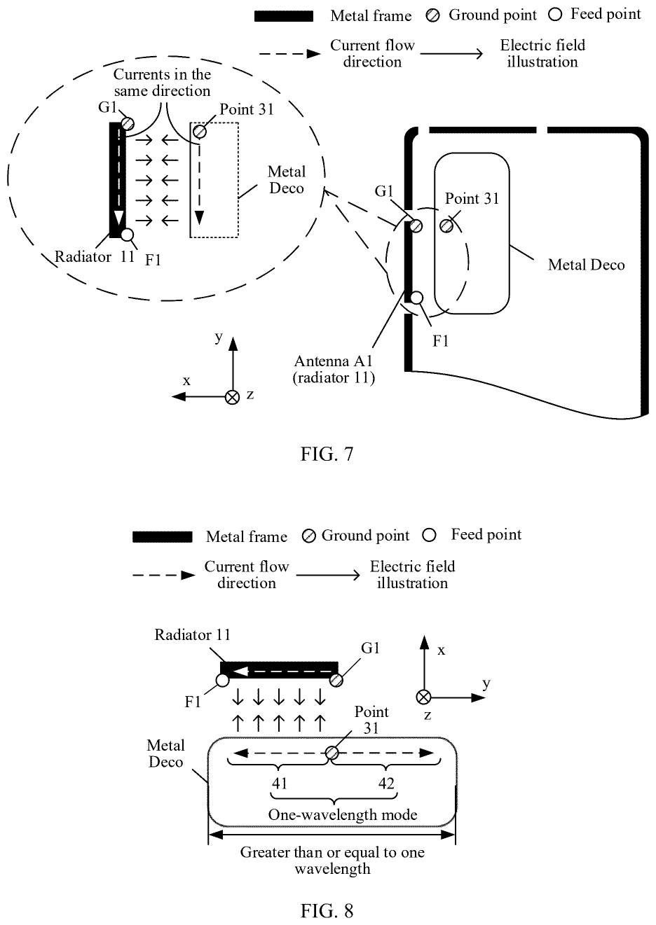

For example, FIG. 7 is an example of a solution of a terminal antenna according to an embodiment of this application.

The antenna solution shown in FIG. 7 may include at least two logical components: an antenna body and a metal Deco.

The antenna body may correspond to the antenna A1 in the existing design (for example, the design shown in FIG. 4 to FIG. 6).

With reference to the description of FIG. 6, the antenna A1 may be a side frame antenna. One ground point and one feed may be provided on the radiator 11 of the antenna A1. The feed may be located at one end of the radiator 11, for example, a lower end corresponding to the negative direction of the y-axis. The ground point may be located at the other end of the radiator 11, for example, an upper end corresponding to the positive direction of the y-axis.

At least one ground point may be provided on the metal Deco.

In some implementations of this application, the antenna A1 shown in FIG. 7 may also be referred to as a first antenna. The radiator 11 of the antenna A1 may be referred to as a first radiator. The metal Deco may be used as a part of the first antenna, for example, the metal Deco may be referred to as a second radiator.

For example, the at least one ground point may include a point 31 for a grounding setting. In some implementations, the point 31 may be referred to as a second ground point.

As shown in FIG. 7, the point 31 may be provided on the metal Deco one side of the radiator 11 of the antenna A1.

The point 31 may be provided close to a large return-to-ground current point of the antenna A1.

For example, the antenna A1 in FIG. 7 is used as an example. The large return-to-ground current point of the antenna A1 may be located at a ground point G1 of the antenna A1. For the setting of the point 31 on the metal Deco, reference may be made to the following two limitations (as shown in 1-1 and 1-2):
1-1. In the x direction, the point 31 may be provided on a side of the metal Deco close to the antenna A1. The side close to the antenna A1 may refer to: an edge of the metal Deco close to the antenna A1, or a region on the metal Deco that extends inward (that is, in the negative direction of the x-axis) for a distance not exceeding 10 mm from an edge close to the antenna A1.
1-2. In the y direction, the point 31 may coincide with or be close to a projection (that is, a projection in the negative direction of the x-axis) of G1 on the metal Deco. That the projection of G1 on the metal Deco is close to the point 31 may be understood as: the point 31 is located within a range of +/−15 mm in the y direction of the projection position of G1 on the metal Deco. That is, with a projection point of G1 on the metal Deco as the center, a one-dimensional coordinate is established in the y direction. Therefore, the point 31 may be provided within a range of −15 mm to 15 mm.

In some embodiments of this application, when the setting of the point 31 (or the second ground point) meets the foregoing limitations of 1-1 and 1-2, it can be considered that the second ground point corresponds to the projection position of the first end of the first radiator in the first region. It may be understood that, when the point 31 coincides with a projection of the ground point G1 on the side of the metal Deco close to the radiator 11, the position corresponding to the point 31 may also be referred to as a first position.

It is to be noted that, the first region involved in the embodiments of this application may be a partial region on a side of the second radiator (that is, the metal Deco) close to the antenna A1. The first region may include a region in which the radiator 11 is projected onto the metal Deco. For example, an upper end of the first region may be a position corresponding to the point 31. A lower end of the first region may be a position after the feed F1 of the antenna A1 is projected onto the metal Deco. Alternatively, the lower end of the first region may extend to a lower edge of the metal Deco.

In this example, by providing the point 31, when the antenna A1 is in operation, energy can be coupled to the metal Deco through the point 31, thereby forming a longitudinal current distribution on the metal Deco.

Because the position of the point 31 meets the foregoing limitations shown in 1-1 and 1-2, the current direction at the position corresponding to the radiator 11 of the antenna A1 on the metal Deco (that is, the projection position of the radiator 11 on the metal Deco) can be the same as the current direction on the radiator 11. Therefore, the influence on the radiation process of the antenna A1 caused by the currents in opposite directions shown in FIG. 6 is avoided.

In addition, the longitudinal (that is, y-direction) current on the metal Deco may also be used to improve the radiation performance of the antenna A1 through a one-wavelength mode. In some embodiments, the one-wavelength mode of the longitudinal current may be used to cover the first frequency band. In some other embodiments, the one-wavelength mode of the longitudinal current may be used to cover the second frequency band.

The first frequency band being covered by the longitudinal one-wavelength mode on the metal Deco is used as an example. A center frequency wavelength of the first frequency band is a first wavelength.

Referring to FIG. 8, in some embodiments, the metal Deco having a y-direction size greater than or equal to the first wavelength is used as an example.

Through the return-to-ground setting of the point 31, a y-direction current distribution meeting resonance features of one-wavelength corresponding to the first frequency band can be excited on a side of the metal Deco close to the antenna A1.

For example, as shown in FIG. 8, a current 41 in the negative direction of the y-axis in the same direction as that on the radiator 11 may be distributed from the point 31 to the negative direction of the y-axis. A current 42 in the positive direction of the y-axis may be distributed from the point 31 to the positive direction of the y-axis. The position of the point 31 may be expressed as a current reversal point, that is, a current reversal point corresponding to the one-wavelength mode. Electrical lengths of the current 41 and the current 42 may be close to or equal to ½ of the first wavelength respectively. Therefore, the current 41 and the current 42 may jointly form a current distribution with the resonance features of one-wavelength corresponding to the first frequency band.

In some embodiments, the current 41 may be referred to as a second current. The current 41 and the current 42 may jointly form a third current corresponding to one-wavelength.

Therefore, the one-wavelength mode corresponding to the operating frequency band of the antenna A1 may be excited on the metal Deco in the y direction. That is, the metal Deco can generate one-wavelength resonance corresponding to the first frequency band based on the parasitic principle.

In this way, the resonance of the longitudinal one-wavelength mode generated by the metal Deco and the resonance generated by the antenna A1 can be superimposed in space and jointly cover the first frequency band, thereby improving the radiation performance of the antenna A1 on the first frequency band.

It is to be noted that, in some embodiments, after the point 31 is provided on the metal Deco, the metal Deco can be directly grounded from the point 31.

In some other embodiments, after the point 31 is provided on the metal Deco, a matching circuit may be further provided between the point 31 on the metal Deco and a reference ground. For example, the matching circuit may include at least one of an inductor, a capacitor, or a resistor. The type and quantity of components in the matching circuit may be specifically selected according to the actual situation.

The matching circuit including a capacitor is used as an example. A capacitor with a capacitance of 0 pF to 10 pF may be set. The capacitor may be configured to tune the coupling between the metal Deco and the antenna A1 at the point 31. Therefore, a better one-wavelength mode can be excited for radiation on the metal Deco.

In this way, by providing the point 31 for grounding on the metal Deco, a current in the same direction can be generated in a region on the metal Deco corresponding to the antenna A1, thereby avoiding the influence of the grounding of the metal Deco on the operation of the antenna A1. In addition, by exciting the one-wavelength mode on the metal Deco, the radiation performance of the antenna A1 can be improved.

With reference to the foregoing description, providing the matching circuit between the point 31 and the reference ground can achieve relevant adjustments. In some embodiments, by properly adjusting capacitances and inductances of the components on the matching circuit, the resonance corresponding to the longitudinal (y-direction) one-wavelength mode of the metal Deco can be tuned to the first frequency band.

In some other embodiments of this application, more ground points may be provided on the metal Deco to tune the frequency band covered by the one-wavelength.

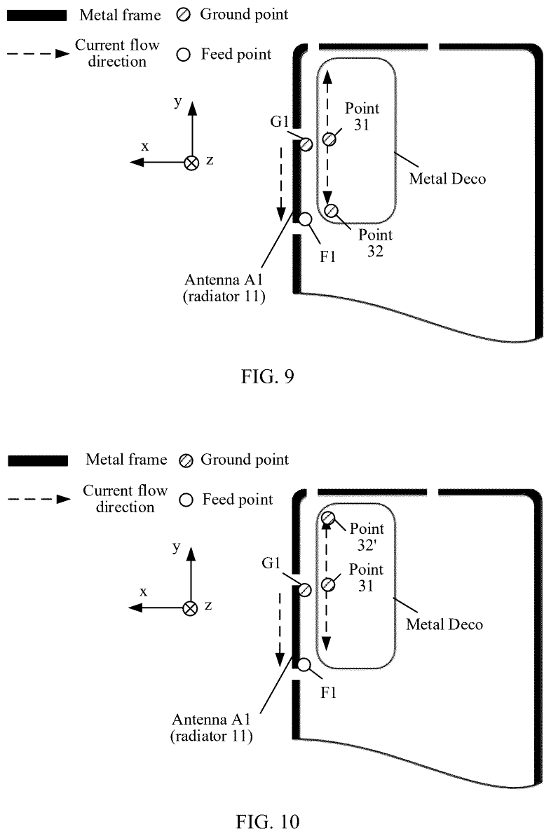

For example, referring to FIG. 9, a point 32 for grounding may be provided on a lower side (in the negative direction of the y-axis) of the point 31. A y-direction distance between the point 32 and the point 31 may be controlled to be ½ of the first wavelength. In some implementations, the y-direction distance between the point 32 and the point 31 may also be described as a distance from the point 32 to a first straight line. The first straight line may be a straight line passing through the point 31, and the first straight line may be perpendicular to a straight line on which the radiator 11 is located. That is, the first straight line may be a straight line along the x-axis passing through the point 31.

In this way, the point 32 can effectively divert the y-direction current on the metal Deco to the reference ground at a position half a wavelength away from point 31, thereby tuning the frequency band covered by the one-wavelength mode tuning on the metal Deco to the first frequency band. In this example, the point 32 may also be referred to as a third ground point. The y-direction current corresponding to the one-wavelength mode on the metal Deco may be referred to as a third current. The current between the point 32 and the point 31 may be the second current. The current on the radiator 11 may be the first current. On the metal Deco, the distribution region of the second current can correspond to the first region on the metal Deco. That is, the third current includes the second current. The second current and the first current has the same direction.

Similar to the arrangement of the matching circuit for the point 31, in some embodiments, a matching circuit may also be arranged between the point 32 and the reference ground. The matching circuit may include at least one of a capacitor, an inductor, or a resistor. The matching circuit may be configured to tune the one-wavelength on the metal Deco.

For example, when the y-direction size of the metal Deco is less than 2/2 times the first wavelength, the point 32 may be provided at the bottom of the metal Deco in the negative direction of the y-axis. An inductor may be provided in the matching circuit between the point 32 and the reference ground, thereby increasing a return-to-ground electrical length of the point 31 on the metal Deco. The one-wavelength mode on the metal Deco is then tuned to be close to the first frequency band.

It may be understood that, as shown in the example of FIG. 9, on the side of the metal Deco close to the antenna A1, a point 32 is provided at ½ wavelength below the point 31, to tune the frequency band covered by the one-wavelength mode. Correspondingly, in some other embodiments, the ground point for diverting and controlling the electrical length of the one-wavelength mode may alternatively be set above the point 31.

For example, with reference to FIG. 10, a point 32′ for grounding may be provided on the metal Deco. A y-direction distance between the point 32′ and the point 31 may be controlled to be about ½ of the first wavelength. In this way, the effect of adjusting the electrical length corresponding to the current 42 in the current distribution of the one-wavelength mode is achieved. Similar to the setting of the point 32, in the example shown in FIG. 10, by setting the point 32′, the one-wavelength mode on the metal Deco can also be tuned to be close to the first frequency band. For the setting and deformation related to the point 32′, reference may be made to the description of the point 32. For example, a matching circuit may be set between the point 32′ and the reference ground.

The foregoing description of FIG. 9 and FIG. 10 illustrate the y-direction size setting of the point 32 (or the point 32′). In different implementations, the x-direction position of the point 32 (or the point 32′) may be flexible. The point 32 is used as an example.

In some embodiments, an x-direction coordinate of the point 32 may be the same as or close to an x-direction coordinate of the point 31. That is, the point 32 may be provided on the side of the metal Deco close to the antenna A1.

In some other embodiments, the x-direction coordinate of the point 32 may be different from that of the point 31. For example, the point 32 may be provided on a side of the see Deco away from the antenna A1.

In the embodiments of this application, under different x-direction settings, by controlling a longitudinal (y-direction) coordinate difference between the point 32 and the point 31 to ½ of the first wavelength, even if a line between the point 32 and the point 31 has an angle with the y-axis (that is, the current returns to the ground in the direction pointing to the lower right), based on orthogonal decomposition, the oblique current can also be decomposed into a part of the y-direction one-wavelength mode (for example, the current 41). Therefore, the effect of tuning the y-direction one-wavelength mode on the metal Deco is achieved by providing the point 32.

In some other implementations of this application, the metal Deco may also be provided with both the point 32 shown in FIG. 9 and the point 32′ shown in FIG. 10. Therefore, by providing the point 32 and the point 32′, and adjusting the electrical length of the return-to-ground current on two sides of the point 31, the one-wavelength mode on the metal Deco can cover the first frequency band more accurately.

In the foregoing solution examples in FIG. 7 to FIG. 10, at least one ground point is provided on the metal Deco to excite the longitudinal (y-direction) one-wavelength mode on the metal Deco. Therefore, the influence on the radiation of the antenna A1 is avoided, and the radiation performance of the antenna A1 on the first frequency band is improved.

It may be understood that, the foregoing example is described by using an example in which the first frequency band is covered by longitudinal one-wavelength. In some other embodiments, the longitudinal one-wavelength may also be used to cover the second frequency band or other frequency bands. For a specific implementation thereof, reference may be made to the description in the foregoing FIG. 7 to FIG. 10, and details are not described herein again.

In some other embodiments of this application, a ground point is provided on the metal Deco, which can also be used to couple the transverse (x-direction) current generated on the metal Deco. The transverse current can also be used to improve the radiation performance of the operating frequency band. An example in which the radiation performance of the second frequency band is improved by using the transverse current is used. The wavelength of the center frequency of the second frequency band may be a second wavelength.

For example, in some embodiments, the transverse current can cover the second frequency band through a ½ wavelength mode, thereby improving the radiation performance of the second frequency band. In some other embodiments, the transverse current can cover the second frequency band through a ¼ wavelength mode, thereby improving the radiation performance of the second frequency band.

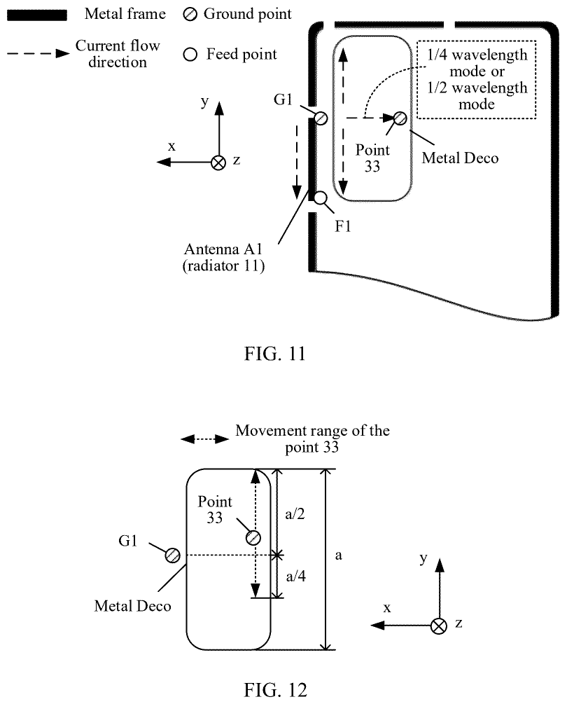

With reference to the descriptions in FIG. 7 to FIG. 10, referring to FIG. 11, in this example, a point 33 may be provided on the metal Deco for grounding. By providing the point 33, the effect of exciting the transverse current can be achieved.

In this example, the position of the point 33 can meet the following two limitations (shown in 2-1 and 2-2):
2-1. In the y direction, the y-direction coordinate parameters of the point 33 and the large return-to-ground current point G1 of the antenna A1 are the same or similar. From another perspective, the point 33 may be provided on a straight line on which the projection of the ground point G1 of the antenna A1 onto the metal Deco along the x-axis is located.
2-2. In the x direction, a distance between the point 33 and an edge of the metal Deco close to the antenna A1 may be controlled to be ¼ of the second wavelength or ½ of the second wavelength.

From another perspective, the point 33 may also be referred to as a fourth ground point, and the position of the fourth ground point may be described as that a distance between the fourth ground point and a second straight line corresponds to ½ wavelength or ¼ wavelength of the second frequency band. The second straight line may be a straight line in the direction of the y-axis (that is, parallel to the straight line on which the radiator 11 is located). The second straight line may pass through the point 31 (for example, the first position).

In this example, by providing the point 33, the energy on the antenna A1 can be coupled to the metal Deco and then flow back to the reference ground at the point 33 in the transversal direction. Therefore, a transverse current is excited on the metal Deco.

In different implementations, by limiting the position of the point 33, the transverse current can correspond to the ½ wavelength or ¼ wavelength mode of the second frequency band. Therefore, the transverse current can cover the second frequency band in the ½ wavelength mode or the ¼ wavelength mode.

For example, in some embodiments, an example in which a transverse (x-direction) length between the point 33 and the corresponding position of G1 on the metal Deco (that is, the position of the foregoing point 31) is ¼ of the second wavelength is used. Acquisition of a transverse ¼ wavelength mode can be excited on the metal Deco to cover the second frequency band.

In some other embodiments, an example in which a transverse (x-direction) length between the point 33 and the corresponding position of G1 on the metal Deco (that is, the position of the foregoing point 31) is ½ of the second wavelength is used. Acquisition of a transverse ½ wavelength mode can be excited on the metal Deco to cover the second frequency band.

In this way, by exciting the transverse current on the metal Deco, the second frequency band is covered. It may be understood that, when the operating frequency band of the antenna A1 includes the second frequency band, the ½ wavelength mode or ¼ wavelength mode covering the second frequency band excited on the metal Deco can be superimposed on the radiation of the antenna A1, thereby improving the radiation performance of the antenna A1 on the second frequency band. When the operating frequency band of the antenna body (that is, the radiator 11) of the antenna A1 does not include the second frequency band, by exciting the ½ wavelength mode or ¼ wavelength mode on the metal Deco to cover the second frequency band, the frequency band coverage of the antenna A1 is extended.

It is to be noted that, with reference to the foregoing description of 2-1, in a specific implementation process, the y-direction (that is, longitudinal) setting of the point 33 may be limited by other components, so that it is difficult to accurately keep consistent with the y-direction coordinate of the ground point G1. Correspondingly, in some embodiments of this application, the y-direction coordinate of the point 33 may alternatively be close to the coordinate parameters of G1. For example, FIG. 12 shows an example of a setting range of the point 33 according to an embodiment of this application. The point 33 is provided within a range extending a/2 in the positive direction of the y-axis (upward as shown in FIG. 12) and extending a/4 in the negative direction of the y-axis (downward as shown in FIG. 12) with the y coordinate of G1 as the origin. a is a total y-direction length of the metal Deco. In this way, even if the point 33 is not strictly provided on the right side of G1, the point 33 can adjust the oblique current distributed on the metal Deco, and can be decomposed into two current modes of longitudinal one-wavelength and transverse ¼ wavelength or ½ wavelength through orthogonal decomposition. Therefore, the radiation performance of the antenna A1 is improved without affecting the antenna A1

FIG. 12 above gives an example of the y-direction setting range of the point 33 based on a specific size. In some other embodiments, an example in which the point 33 is used to excite the transverse ¼ wavelength on the metal Deco is used, and the y-direction setting range of the point 33 may alternatively be: a range extending upward for ¼ wavelength and extending downward for ¾ wavelength with the y coordinate of G1 as the origin.

In addition, a corresponding matching circuit may also be arranged between the point 33 and the reference ground. For the arrangement of the matching circuit, reference may be made to the matching circuit corresponding to the point 31 in the foregoing example. The functions and arrangement manners of the two points are similar, and details are not described herein again.

It is to be noted that, in this example, the setting of the point 33 does not change the boundary condition of the metal Deco relative to the antenna body of the antenna A1. Therefore, the setting of the point 33 does not affect the coupling state from the ground point G1 to the metal Deco on the radiator 11. In this way, after the point 33 is provided, when the transverse current in the foregoing implementation can be excited, the longitudinal one-wavelength mode shown in FIG. 7 or FIG. 8 can also be distributed on the metal Deco.

That is, by providing the point 33 shown in FIG. 11, the longitudinal one-wavelength mode and the transverse ½ wavelength mode or ¼ wavelength mode can be simultaneously excited on the metal Deco.

In some implementations, the longitudinal mode can be used to cover the first frequency band. The transverse mode can be used to cover the second frequency band.

The following describes the effect of providing the point 33 with reference to specific simulation results.

For example, exciting the transverse ½ wavelength by providing the point 33 is used as an example.

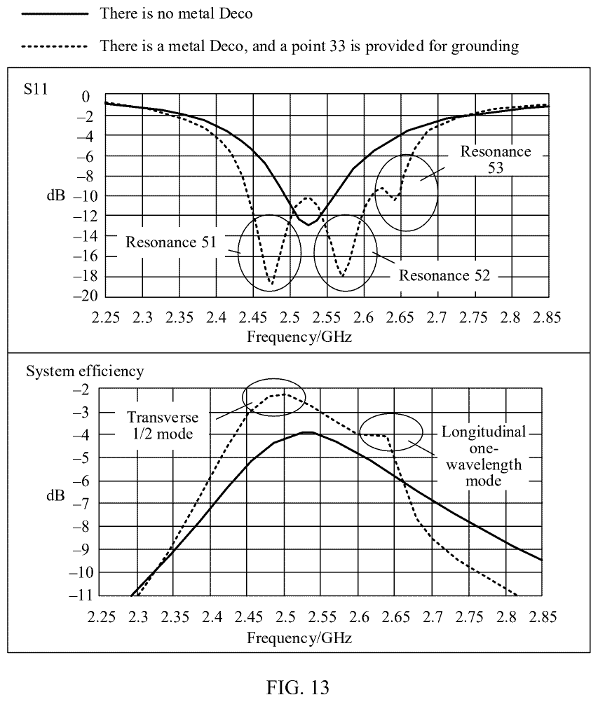

As shown in FIG. 13, the operating frequency band of the antenna A1 (that is, the foregoing first frequency band) covering the 2.4G WIFI frequency band is used as an example.

As shown in S11 (that is, return loss) in FIG. 13, a case in which no metal Deco is set is compared. When the metal Deco is set and the point 33 is set to be grounded according to the solution shown in FIG. 11 or FIG. 12, three resonances may be shown on S11, for example, resonance 51 to resonance 53. The resonance 51 may correspond to a resonance of the transverse ½ mode on the metal Deco. The resonance 52 may correspond to a resonance generated by the antenna body part (that is, the radiator 11) of the antenna A1. The resonance 53 may correspond to a resonance of the longitudinal one-wavelength mode on the metal Deco. It can be seen that in terms of the return loss, even if the metal Deco is set, the bandwidth is significantly improved due to the application of the setting of the point 33 provided in this application. The resonance depth is also significantly optimized.

As shown in the system efficiency in FIG. 13, a case in which no metal Deco is set is compared. When the metal Deco is set and the point 33 is set to be grounded according to the solution shown in FIG. 11 or FIG. 12, the efficiency near 2.4 GHz to 2.5 GHz is significantly improved. The efficiency peak value of the transverse ½ wavelength mode (that is, the mode corresponding to the resonance 51) is close to −2 dB. The efficiency peak value of the longitudinal one-wavelength mode (that is, the mode corresponding to the resonance 53) is close to −4 dB.

Therefore, through the grounding setting shown in FIG. 11 or FIG. 12, exciting the transverse and longitudinal modes can effectively improve the radiation performance of the antenna A1. It may be understood that, the FIG. 13 above is described by using excitation of the transverse ½ wavelength mode on the metal Deco as an example. In some other embodiments, by adjusting the x-direction coordinate parameters of the point 33, a similar effect can be achieved by exciting the ¼ wavelength mode on the metal Deco.

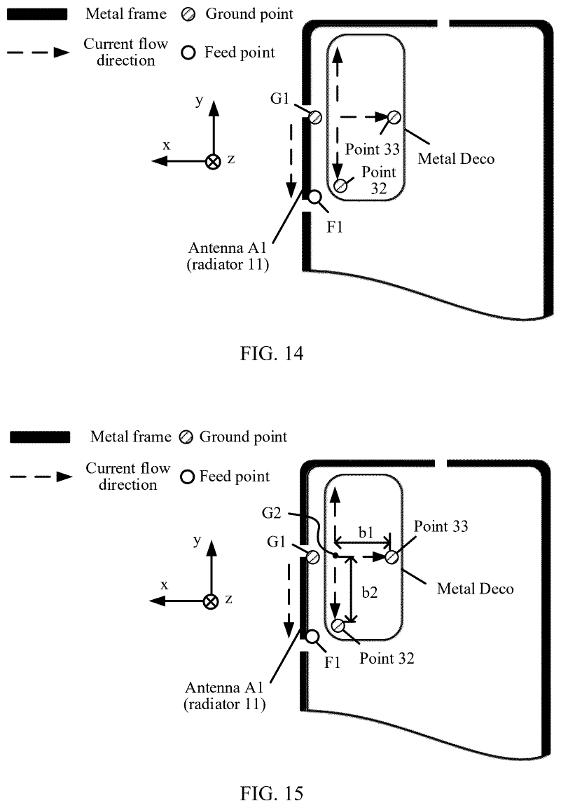

In the description of FIG. 11 to FIG. 13 above, the setting of the point 33 can simultaneously excite the transverse mode and the longitudinal mode on the metal Deco. In some embodiments, with reference to the description of FIG. 9 above, referring to FIG. 14, when the point 33 is provided on the metal Deco, the point 32 may also be provided close to an edge of the antenna A1. The y-direction coordinate of the point 32 is different from the y-direction coordinate of the point 33. The setting of the point 32 can be used to control the current of the longitudinal one-wavelength mode to return to the ground, thereby tuning the one-wavelength mode to the required frequency band.

For example, the longitudinal one-wavelength mode being used to cover the first frequency band is used as an example. Therefore, the y-direction coordinate difference between the point 32 and the point 33 can correspond to ½ of the first wavelength. By adjusting the point 32, the current distribution on the side of the metal Deco close to the antenna A1 meets the distribution features of the one-wavelength mode corresponding to the first frequency band. Therefore, the longitudinal one-wavelength mode is tuned to the first frequency band.

In the grounding solution shown in FIG. 14, the transverse mode can also be excited on the metal Deco based on the foregoing description of FIG. 11.

Referring to FIG. 15, an example in which an x-direction projection of G1 on the side of the metal Deco close to the antenna A1 is G2, and the ½ wavelength mode is transversally excited on the metal Deco is used. By adjusting a transverse (x-direction) distance b1 between the point 33 and G2, and a longitudinal (y-direction) distance between the point 32 and G2, the frequency bands covered by the transverse ½ wavelength mode and the longitudinal one-wavelength mode can be adjusted.

For example, in the foregoing example, the transverse ½ wavelength mode covering the second frequency band, and the longitudinal one-wavelength mode covering a low frequency band is used as an example. Therefore, b1 may be set to correspond to ½ of the first wavelength, and b2 may be set to correspond to ½ of the second wavelength.

The transverse ¼ wavelength mode covering the second frequency band and the longitudinal one-wavelength mode covering the low frequency band is used as an example. Therefore, b1 may be set to correspond to ½ of the first wavelength, and b2 may be set to correspond to ¼ of the second wavelength.

In other cases, the manner of adjusting the frequency bands covered by the transverse ½ wavelength mode and the longitudinal one-wavelength mode may be correspondingly adjusted with reference to the foregoing examples, and details are not described herein again.

Therefore, based on the description of FIG. 14 and FIG. 15, two ground points may be simultaneously provided on the metal Deco to achieve the excitation of the transverse mode and the longitudinal mode. The frequency bands covered by the transverse mode and the longitudinal mode may be the same or different.

In some other embodiments of this application, three ground points may alternatively be simultaneously provided on the metal Deco. By adjusting the positions of the three ground points, the excitation of the transverse mode and the longitudinal mode is further tuned.

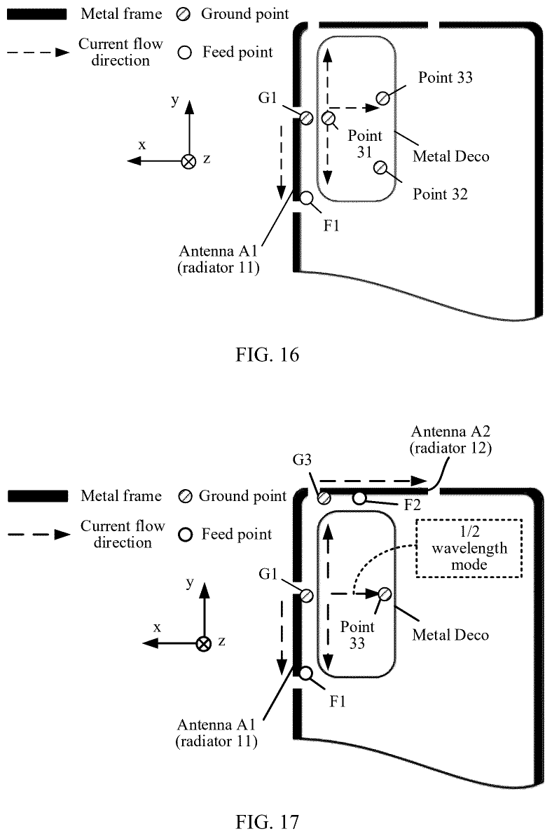

For example, referring to FIG. 16, a point 31, a point 32, and a point 33 may be simultaneously set on metal Deco.

For settings of the point 31, the point 32, and the point 33, reference may be made to the descriptions in the foregoing examples respectively. For specific implementations thereof, reference may be made to each other.

It is to be noted that, as the foregoing description for the setting of the point 32, in the example shown in FIG. 16, the x-direction position of the point 32 may also be flexibly selected. For example, the point 32 may be provided below the point 31, that is, the side of the metal Deco close to the radiator 11. In another example, the point 32 may be provided below the point 33, that is, the side of the metal Deco away from the radiator 11. In different implementations, the longitudinal mode covering the first frequency band is used as an example, and the y-direction coordinate difference between the point 32 and the point 31 or the point 33 may be controlled to be near ½ of the first wavelength. Therefore, the frequency band covered by the longitudinal mode is tuned to be near the first frequency band.

In the foregoing solution description, the electronic device being provided with a side antenna A1 is used as an example, to describe the arrangement and effect of the metal Deco. It may be understood that, when the antenna A1 is arranged at another position close to the metal Deco, the position of the ground point on the metal Deco can be correspondingly adjusted to achieve a corresponding effect.

It may be understood that, in the foregoing examples, the antenna A1 being a left-hand antenna is always used as an example. When the antenna A1 is implemented in other forms, a grounding position (for example, the point 31) on a longitudinal close side of the metal Deco may be synchronously adjusted according to a change of a large-current point of the antenna body on the antenna A1 as required. By adjusting the corresponding point 31 to be near a region of the large-current point of the antenna body on the antenna A1, the coupling strength can be improved to achieve relatively good excitation the longitudinal one-wavelength.

Therefore, by providing at least one ground point (for example, at least one of the points 31 to 33) on the metal Deco near antenna A1, the metal Deco can participate in effective radiation as a part of the antenna A1, thereby improving the radiation capability of the antenna A1 while avoiding the influence of the metal Deco the on antenna A1.

It may be understood that, antennas other than the antenna A1 may also be provided in the electronic device. For example, an antenna A2 that is also near the metal Deco may be arranged in the electronic device.

For example, an example in which an antenna A2 is arranged on the top left side of the back view of the electronic device is used. Referring to FIG. 17:

The antenna A2 may be arranged above the metal Deco (that is, in the positive direction of the y-axis). The antenna A2 may include a radiator, for example, a radiator 12. The antenna A2 being a frame antenna in the form of an IFA is used as an example. The antenna A2 may include a ground point G3 arranged at a left-side end of the radiator 12. The antenna A2 may further include a feed F2 arranged on the radiator 12.

When the antenna A2 is in operation, its operating frequency band may be covered by the ½ wavelength mode or the ¼ wavelength mode.

For example, the operating frequency band of the antenna A2 may include the first frequency band and/or the second frequency band. The operating frequency band of the antenna A2 may include at least a part that overlaps with that of the antenna A1. The first frequency band may be the 2.4G WIFI frequency band, and the second frequency band may be the GPS frequency band.

In a specific implementation, when the operating frequency bands of the antenna A1 and the antenna A2 both include the 2.4G WIFI frequency band, the throughput rate of WIFI communication can be effectively improved through dual-antenna 2.4G WIFI coverage.

With reference to the description of FIG. 7 to FIG. 16, In some embodiments, for the antenna A2, a ground point may also be correspondingly provided on the metal Deco, so that the current direction of the transverse mode on the metal Deco is the same as the current direction on the radiator 12, thereby avoiding the influence of the metal Deco on the radiator 12 in operation. In addition, settings corresponding to the point 31, the point 32, and the point 33 in the foregoing examples may alternatively be performed on the metal Deco, to improve the radiation performance of the antenna A2. For specific settings, reference may be made to the foregoing descriptions. Details are not described herein again.

An example in which the three ground points shown in FIG. 16 are provided on the metal Deco to improve the radiation performance of the antenna A1, the transverse mode of the metal Deco is used to cover the second frequency band, and the operating frequency band of the antenna A2 also includes the second frequency band is used.

It may be understood that, because metal Deco is close to both the antenna A1 and the antenna A2, the radiation enhancement effect of the metal Deco can simultaneously act on the two antennas. In this way, for the overlapping parts of the operating frequency bands of the two antennas (such as the first frequency band and/or the second frequency band), the problem of poor isolation may occur, thereby affecting the radiation performance of the two antennas in the corresponding frequency bands.

For this, in the embodiments of this application, the transverse mode of the metal Deco may be tuned to the ½ wavelength mode to reduce the mutual influence between the two antennas.

It may be understood that, when the transverse mode excites the ½ wavelength mode, a maximum-current point of the transverse mode may be close to the position of the top antenna feed (that is, the feed F2 of the antenna A2). The feed F2 of the antenna A2 may correspond to a large-current point of the antenna A2. When large-current points of two modes (such as the transverse mode on metal Deco and a mode excited on antenna A2 for covering the same frequency band) are close to each other, the mutual interference between the two modes can be effectively controlled.

For example, the transverse mode on the metal Deco being used to cover the first frequency band is used as an example.

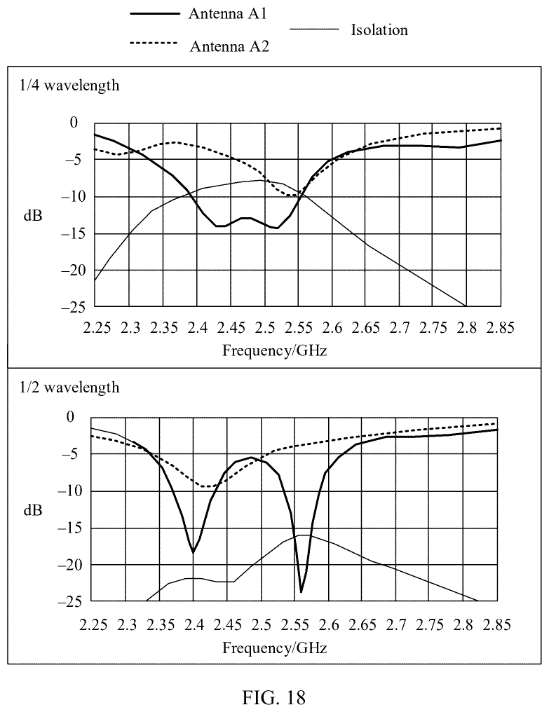

FIG. 18 shows simulation of isolation between the antenna A1 and the antenna A2 when both the antenna A1 and the antenna A2 use the ½ wavelength mode to cover the first frequency band and use the ¼ wavelength mode to cover the first frequency band. The ½ wavelength mode may be the ½ wavelength mode of the transverse current. Because the metal Deco is used to improve the radiation performance of the antenna A1, in the embodiments of this application, the transverse mode radiation of the metal Deco is also included in the radiation of the antenna A1.

As shown in FIG. 18, when the antenna A1 and the metal Deco cover the 2.4G WIFI frequency band through the ¼ wavelength mode, and the antenna A2 covers the 2.4G WIFI frequency band through the ¼ wavelength mode, the dual-port isolation of the antenna A1 and the antenna A2 is relatively poor, and the worst point is close to −8 dB. Therefore, there will be relatively obvious interference between the two antennas.

When metal Deco covers the 2.4G WIFI frequency band through the ½ wavelength mode, and the antenna A2 covers the 2.4G WIFI frequency band through the ½ wavelength mode, the dual-port isolation of the antenna A1 and the antenna A2 is relatively good, and the worst point is less than-15 dB. Therefore, there will be no relatively obvious interference when the two antennas are simultaneously in operation.

It may be understood that, when antenna A2 covers the first frequency band through ¼ wavelength, and the transverse mode on the metal Deco is a ½ wavelength mode, because the two modes are different, and the current distributions are also different, the isolation will be better and the mutual interference will be less.

In summary, in the embodiments of this application, by properly setting the position of the point 33 on the metal Deco, the metal Deco can cover the first frequency band or the second frequency band through the ½ wavelength mode. Therefore, the isolation between the antenna A1 and the antenna A2 is ensured, thereby improving the radiation performance of the entire antenna system.

Therefore, based on the foregoing description of FIG. 7 to FIG. 18, the antenna solution provided in the embodiments of this application can avoid the influence on the antenna when the metal Deco is arranged close to the antenna by providing at least one ground point (for example, at least one of the point 31 to point 33) on the metal Deco. In addition, by providing the at least one ground point, the longitudinal one-wavelength mode and/or the transverse ½ wavelength mode (or the transverse ¼ wavelength mode) on the metal Deco can further be excited to improve the radiation performance of the original antenna. This solution may also be applied to an antenna system including a plurality of frame antennas. By controlling the transverse mode on the metal Deco to operate in the ½ wavelength mode, the isolation between adjacent antennas is optimized, so that the entire antenna system can obtain better radiation performance.

For example, as shown in FIG. 19, when the antenna solution provided in the embodiments of this application (that is, the metal Deco grounding solution) is applied to an antenna system including the antenna A1 and the antenna A2, frequency bands covered by the antenna A1 and the antenna A2 may at least partially overlap. The antenna A1 and the antenna A2 may be respectively located on two vertical sides close to the metal Deco.

In this example, a point 31, a point 32, and a point 33 may be provided on the metal Deco. Any one or more of the point 31, the point 32, and the point 33 may be provided with a matching circuit with the reference ground. The point 31 may be configured to excite the longitudinal one-wavelength current on the side of the metal Deco close to the antenna A1, thereby achieving the excitation of the current in the same direction at the position corresponding to the radiator 11 of the antenna A1 on the metal Deco. The point 32 may be configured to tune a grounding position of a longitudinal one-wavelength current, so that the longitudinal one-wavelength can cover or partially cover the first frequency band and/or the second frequency band. The point 33 may be configured to excite the transverse ½ wavelength mode, for covering or partially covering the first frequency band and/or the second frequency band. In this way, the metal Deco can perform radiation as a part of the antenna A1. Therefore, through the setting of the point 31 to the point 33 on the metal Deco, the metal Deco may be included in the antenna A1 in terms of logical division. That is, the radiator of the antenna A1 includes the radiator 11 and the metal Deco.

With reference to the foregoing description of FIG. 17 to FIG. 19, the transverse ½ wavelength corresponding to the point 33 can improve the isolation between the antenna A1 and the antenna A2. Therefore, even if the operating frequency band of the antenna A2 includes the frequency band covered by the transverse ½ wavelength on the metal Deco, the isolation between the antenna A1 and the antenna A2 can be controlled in a relatively good manner.

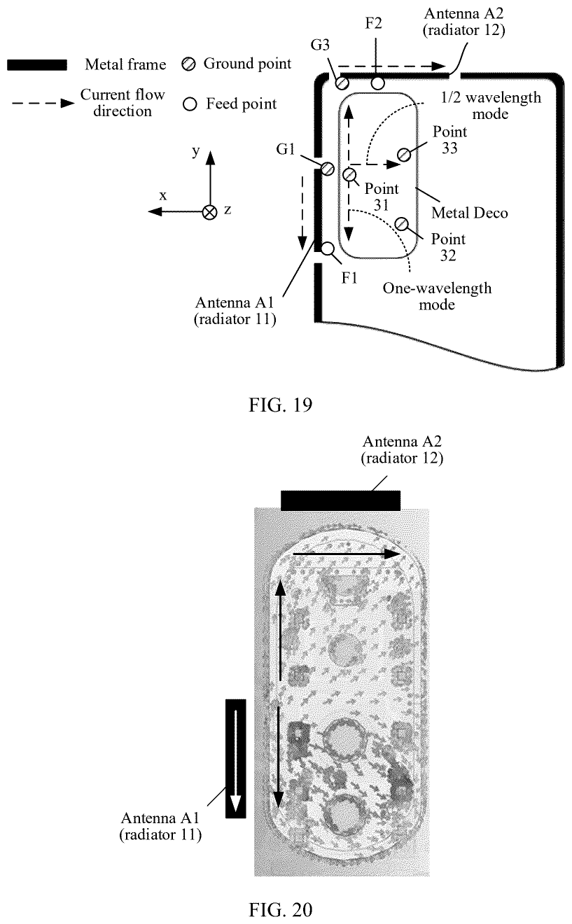

As a comparison, a comparative description of the effects between the technical solution provided in the embodiments of this application and a conventional design is provided below with reference to FIG. 20 to FIG. 22. The solution provided in the embodiments of this application using the design shown in FIG. 19 is used as an example. The existing design may correspond to the design shown in FIG. 5 or FIG. 6. In the system efficiency simulation, the efficiency comparison of the first frequency band (that is, 2.4G WIFI frequency band) is used for an exemplary description.

FIG. 20 illustrates simulation of a current on the metal Deco during operation of the solution provided in the embodiments of this application. A darker color indicates a stronger current.

As shown in FIG. 20, on the metal Deco, the longitudinal current presents a one-wavelength distribution. The frame antenna current and the metal Deco edge current has the same direction, and a small-current point of the metal Deco edge corresponds to a large-current point of the frame, which is EH electromagnetic coupling. The metal Deco is distributed transversally at ½ wavelength, and the position of the large-current point is basically consistent with the position of the large-current point of the frame antenna (for example, the antenna A2), which is HH magnetic coupling.

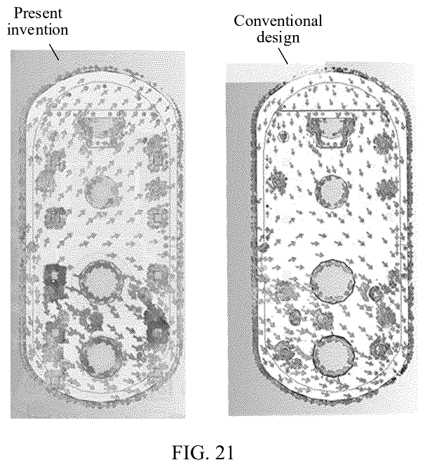

FIG. 21 shows a comparison of current distributions between the solution provided in the embodiments of this application and a conventional design. Ranges of the solution provided in the embodiments of this application and the conventional design are the same. A darker color indicates a stronger current.

As shown in FIG. 21, in the conventional design, the current on the decoration member is weak overall. Moreover, the current direction on the side of the metal Deco close to the antenna A1 is opposite to the current direction on the antenna A1.

Correspondingly, in the solution provided in the embodiments of this application, a relatively strong current is distributed on the metal Deco. The relatively strong current distribution can support the metal Deco to perform effective radiation in the longitudinal mode and the transverse mode.

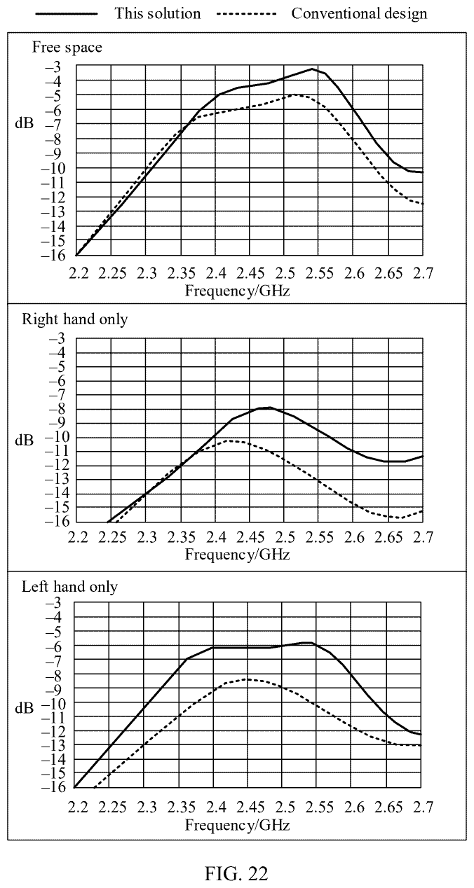

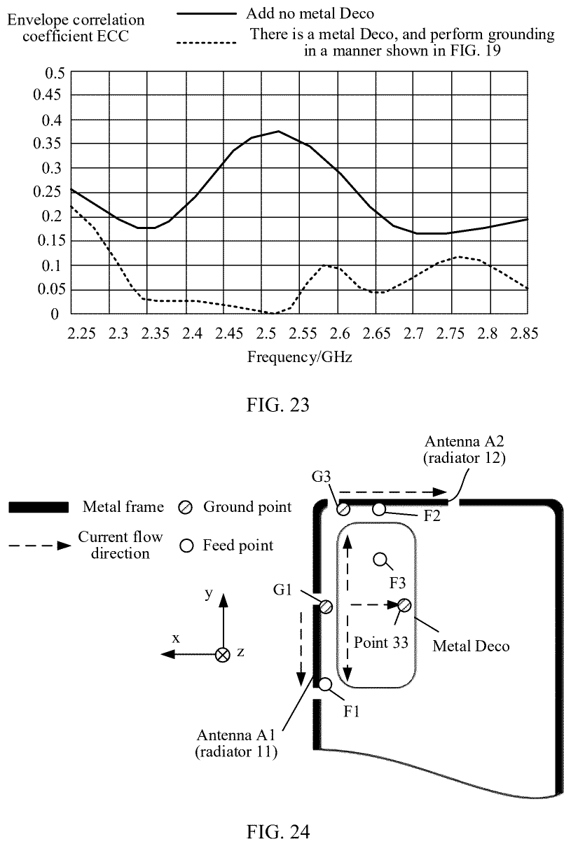

FIG. 22 illustrates system efficiency simulation between the solution provided in the embodiments of this application and a conventional solution. In the example shown in FIG. 22, a comparison between efficiency under hand only scenarios (such as left hand only and right hand only) is also provided.

As shown in the example of simulation of the free space (FS) scenario in FIG. 22, in the solution provided in the embodiments of this application, an efficiency peak value is close to −3 dB. Correspondingly, an efficiency peak value in the conventional design is only −5 dB. The −6 dB bandwidth in the solution provided in this application is also significantly higher than that in the conventional design.

As shown in the example of simulation of the right hand only scenario in FIG. 22, the right hand only peak value efficiency in the solution provided in this application reaches −8 dB. Correspondingly, the right hand only efficiency peak value in the conventional design is less than −10 dB. In addition, in terms of a right hand only efficiency bandwidth comparison, the bandwidth in the solution provided in this application is significantly higher than that in the conventional design. With reference to the free space simulation result in FIG. 21, right hand only reductions are compared to obtain a difference. In this application, the peak value reduction is less than 5 dB, while the corresponding peak value reduction in the conventional design is more than 5 dB.

As shown in the example of simulation of the left hand only scenario in FIG. 22, the right hand only peak value efficiency in the solution provided in this application reaches −6 dB. Correspondingly, the left hand only efficiency peak value in the conventional design is less than-8 dB. In addition, in terms of a left hand only efficiency bandwidth comparison, the bandwidth in the solution provided in this application is significantly higher than that in the conventional design. With reference to the free space simulation result in FIG. 21, left hand only reductions are compared to obtain a difference. In this application, the peak value reduction is less than 3 dB, while the corresponding peak value reduction in the conventional design is more than 3 dB.

Based on the simulation result in FIG. 22, compared with the conventional design, the solution provided in this application has a higher efficiency peak value and a smaller hand only reduction. In other words, the radiation performance of the solution shown in FIG. 19 is significantly better than that of the conventional design. It may be understood that, with reference to the foregoing principle description, in other implementations of this application, the beneficial effects thereof are similar, and details are not described herein again.

It is to be noted that, in the same-frequency or adjacent-frequency dual-antenna design shown in FIG. 19, the correlation between amplitudes for receiving signals between different antenna units may usually be represented by an envelope correlation coefficient (ECC).

In the solution provided in the embodiments of this application, with reference to the introduction of FIG. 17, the transverse ½ wavelength mode is excited on the metal Deco to improve the isolation between the antenna A1 and the antenna A2. FIG. 23 illustrates a comparison of ECC simulation between this solution and a conventional design. The first frequency band (2.4G WIFI frequency band) is still used as an example for description.

In the conventional design, the ECC increases significantly in a relatively high-efficiency frequency band (for example, near 2.5 GHZ). This indicates that the mutual influence of the two antennas in this frequency band increases significantly.

Correspondingly, in the solution provided in this application, the ECC is kept below 0.1 in the full 2.4G WIFI frequency band. This indicates that the two antennas have relatively good independent operating capabilities. When either antenna is in operation, the antenna is basically not affected by the other antenna.

In some other embodiments of this application, in addition to any possible implementation shown in FIG. 7 to FIG. 23 above, an independent feed may also be provided on the metal Deco to facilitate independent radiation of the metal Deco to cover a third frequency band different from the first frequency band or the second frequency band.

For example, referring to FIG. 24, a feed F3 may be provided on the metal Deco. The feed F3 may be configured to excite the metal Deco to operate on the third frequency band. The third frequency band may correspond to an area of the metal Deco. A larger area of the metal Deco indicates that the third frequency band is more likely to be low-frequency. Conversely, a smaller area of the metal Deco indicates that the third frequency band is more likely to be high-frequency.

In some embodiments of this application, a corresponding matching circuit may also be provided between the feed F3 and the metal Deco for tuning the third frequency band. The design of the matching circuit may also be used to better preserve a boundary condition corresponding to any one of the foregoing ground points 31 to 33, so that the metal Deco will not significantly affect the transverse mode and the longitudinal mode in the foregoing examples while performing radiation on the third frequency band.

In a possible implementation, the feed F3 being provided at a position of a large current of the metal Deco is used as an example. The matching circuit between the feed F3 and the metal Deco may include a small parallel inductor. The inductance of the small inductor may not exceed 10 nH. The setting of the small parallel inductor may be used for a boundary condition design without destroying the original large-current point. In some other implementations, the matching circuit between the feed F3 and the metal Deco may further include LC circuits in other forms. The specific components in the matching circuit is not limited in the embodiments of this application.

In still another possible implementation, the feed F3 being provided at a position of a large electric field of the metal Deco is used as an example. The matching circuit between the feed F3 and the metal Deco may include a parallel capacitor. The setting of the parallel capacitor may be used for a boundary condition design without destroying the original large-electric-field point.

In this way, based on the foregoing description of FIG. 7 to FIG. 24, a person skilled in the art shall be capable of having a detailed and clear understanding of the technical solution provided in the embodiments of this application. In a specific implementation process, the overall radiation performance of the antenna can be improved by properly selecting ground points on the metal Deco according to the various implementations provided in the foregoing solution.

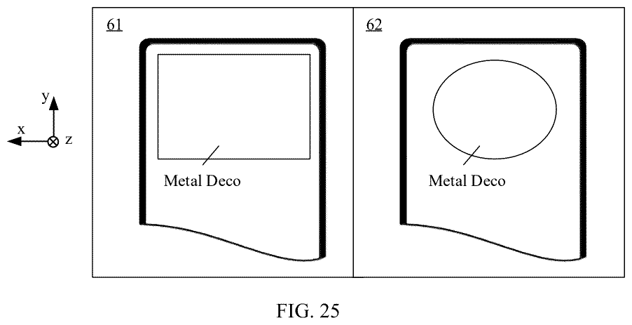

It is to be noted that, in the foregoing examples, an example in which the metal Deco has a rectangular appearance and is arranged in the upper left corner of the back view of the electronic device is used for description. A person skilled in the art shall understand that this solution can also be correspondingly applied to other metal Deco designs. For example, the appearance of the metal Deco may alternatively include a rectangular appearance with a central design shown in 61 in FIG. 25. In another example, the appearance of the metal Deco may alternatively include a circular or elliptical appearance with a central design shown in 62 in FIG. 25. For specific implementations of different metal Decos, reference may be made to the description in the foregoing examples, and the effects that can be achieved are similar. Details are not described herein again.

The foregoing content is only specific implementations of this application, but is not intended to limit the protection scope of this application. Any variation or replacement within the technical scope disclosed in this application shall fall within the protection scope of this application. Therefore, the protection scope of this application shall be subject to the protection scope of the claims.

What is claimed is:

1. A terminal antenna, wherein the terminal antenna is arranged in an electronic device; and
the antenna comprises: a first radiator and a second radiator, wherein
two ends of the first radiator are respectively provided with a first feed point and a first ground point, and the second radiator is provided with at least one ground point;
the first feed point is coupled to a first feed, and the first ground point and the at least one ground point on the second radiator are separately coupled to a reference ground;
when the antenna is in operation, a first current is distributed on the first radiator;
a second current is distributed in a first region on the second radiator; and the first region is on a side of the second radiator close to the first radiator, and the first region corresponds to a region in which the first radiator is projected onto the second radiator; and
the first current and the second current have a same direction.

2. The antenna according to claim 1, wherein the electronic device has a metal frame architecture; and
at least a part of a metal frame of the electronic device is reused for the first radiator, and a metal decoration member in the electronic device is reused for the second radiator.

3. The antenna according to claim 1, wherein a minimum distance between the first radiator and the second radiator does not exceed 15 mm.

4. The antenna according to claim 1, wherein the at least one ground point on the second radiator comprises a second ground point, and the second ground point is provided in the first region.

5. The antenna according to claim 4, wherein
that two ends of the first radiator are respectively provided with a first feed point and a first ground point comprises: a first end of the first radiator is provided with the first ground point; and
that the second ground point is provided in the first region comprises: the second ground point corresponds to a projection position of the first end of the first radiator in the first region.

6. The antenna according to claim 1, wherein an operating frequency band of the antenna comprises a first frequency band;
the at least one ground point on the second radiator comprises a third ground point;
that two ends of the first radiator are respectively provided with a first feed point and a first ground point comprises: the first end of the first radiator is provided with the first ground point;
and the projection position of the first end of the first radiator in the first region is a first position;
a distance between the third ground point and a first straight line corresponds to ½ wavelength of the first frequency band; and
the first straight line passes through the first position, and the first straight line is perpendicular to a straight line on which the first radiator is located.

7. The antenna according to claim 5, wherein
when the antenna is in operation, the first radiator operates on the first frequency band, a third current is distributed on the side of the second radiator close to the first radiator, the third current comprises the second current, and the third current is configured to excite a one-wavelength mode covering the first frequency band on the second radiator.

8. The antenna according to claim 7, wherein a straight line on which the third current on the second radiator is located is parallel to a straight line on which the first current on the first radiator is located.

9. The antenna according to claim 1, wherein the operating frequency band of the antenna comprises a second frequency band;
that the second radiator is provided with at least one ground point comprises: the second radiator is provided with a fourth ground point;
that two ends of the first radiator are respectively provided with a first feed point and a first ground point comprises: the first end of the first radiator is provided with the first ground point;
and the projection position of the first end of the first radiator in the first region is the first position;
a distance between the fourth ground point and a second straight line corresponds to ½ wavelength or ¼ wavelength of the second frequency band; and
the second straight line passes through the first position, and the first straight line is parallel to the straight line on which the first radiator is located.

10. The antenna according to claim 1, wherein
the second radiator is further provided with a second feed point, and the second feed point is coupled to a second feed, wherein
the second feed is configured to feed a signal to the second radiator through the second feed point, so that the second radiator operates on a third frequency band.

11. An antenna system, wherein the antenna system is applicable to an electronic device; and
the antenna system comprises a first antenna and a second antenna;
an operating frequency band of the antenna system comprises a first frequency band, a second frequency band, and a third frequency band;
the first radiator and the second radiator of the first antenna are configured to cover the first frequency band;
the second radiator of the first antenna and the second antenna are configured to cover the second frequency band;
the second radiator of the first antenna is further configured to cover the third frequency band; and
the first antenna the antenna comprises: a first radiator and a second radiator, wherein
two ends of the first radiator are respectively provided with a first feed point and a first ground point, and the second radiator is provided with at least one ground point;
the first feed point is coupled to a first feed, and the first ground point and the at least one ground point on the second radiator are separately coupled to a reference ground;
when the antenna is in operation, a first current is distributed on the first radiator;
a second current is distributed in a first region on the second radiator; and the first region is on a side of the second radiator close to the first radiator, and the first region corresponds to a region in which the first radiator is projected onto the second radiator; and
the first current and the second current have a same direction.

12. The antenna system according to claim 11, wherein
the second radiator of the first antenna comprises the fourth ground point;
the first end of the first radiator of the first antenna is provided with the first ground point;
the projection position of the first end of the first radiator in the first region is the first position;
and the first region is on a side of the second radiator close to the first radiator, and the first region corresponds to a region in which the first radiator is projected onto the second radiator;
the distance between the fourth ground point and the second straight line corresponds to ½ wavelength of the second frequency band; and
the second straight line passes through the first position, and the first straight line is parallel to the straight line on which the first radiator is located.

13. The antenna system according to claim 11, wherein
the electronic device has a metal frame architecture, at least a part of a metal frame on a first side of the electronic device is reused for the first radiator of the first antenna, at least a part of a metal frame on a second side of the electronic device is reused for a radiator of the second antenna, and the first side and the second side are two adjacent sides.

14. The antenna system according to claim 13, wherein a minimum distance from the second radiator of the first antenna to the first side or the second side does not exceed 15 mm.

15. An electronic device, provided with at least one processor, a radio frequency module, wherein
when the electronic device sends or receives signals, the signals are sent or received through the radio frequency module and an antenna; and
the antenna comprises: a first radiator and a second radiator, wherein
two ends of the first radiator are respectively provided with a first feed point and a first ground point, and the second radiator is provided with at least one ground point;
the first feed point is coupled to a first feed, and the first ground point and the at least one ground point on the second radiator are separately coupled to a reference ground;
when the antenna is in operation, a first current is distributed on the first radiator;
a second current is distributed in a first region on the second radiator; and the first region is on a side of the second radiator close to the first radiator, and the first region corresponds to a region in which the first radiator is projected onto the second radiator; and
the first current and the second current have a same direction.

16. The electronic device according to claim 15, wherein the electronic device has a metal frame architecture; and
at least a part of a metal frame of the electronic device is reused for the first radiator, and a metal decoration member in the electronic device is reused for the second radiator.

17. The electronic device according to claim 15, wherein a minimum distance between the first radiator and the second radiator does not exceed 15 mm.

18. The electronic device according to claim 15, wherein the at least one ground point on the second radiator comprises a second ground point, and the second ground point is provided in the first region.

19. The electronic device according to claim 18, wherein
that two ends of the first radiator are respectively provided with a first feed point and a first ground point comprises: a first end of the first radiator is provided with the first ground point; and
that the second ground point is provided in the first region comprises: the second ground point corresponds to a projection position of the first end of the first radiator in the first region.

20. The electronic device according to claim 15, wherein an operating frequency band of the antenna comprises a first frequency band;
the at least one ground point on the second radiator comprises a third ground point;
that two ends of the first radiator are respectively provided with a first feed point and a first ground point comprises: the first end of the first radiator is provided with the first ground point;
and the projection position of the first end of the first radiator in the first region is a first position;
a distance between the third ground point and a first straight line corresponds to ½ wavelength of the first frequency band; and
the first straight line passes through the first position, and the first straight line is perpendicular to a straight line on which the first radiator is located.
